(19) United States
(12) Patent Application Publication
(10) Pub. No.: US 2006/0067494 A1
(43) Pub. Date: Mar. 30, 2006

(54) Systems and methods for providing alternative payment communications systems

(75) Inventors: Thomas Slagle, Boca Raton, FL (US); David A. VanderMeiden, Boca Raton, FL (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Information and Communication Networks, Inc.

(21) Appl. No.: 10/951,362

(22) Filed: Sep. 28, 2004

(51) Int. Cl. H04M 3/08; H04M 15/00

(52) U.S. Cl. 379/114.01; 379/32.01

(57) ABSTRACT

Systems and methods for providing an alternative payment scheme for telecommunications services. The systems and methods according to preferred embodiments of the present invention may include a user communications device capable of playing an electronic content clip; a communications network for transferring electronic content to and from the user communications device; and an electronic content server that stores electronic content clips and provides electronic content clips to the user communications device such that an electronic content clip must be reviewed by a user prior to the user completing an electronic communication with the user communications device.

### BACKGROUND OF THE INVENTION

The present invention relates generally to communication systems and, more particularly, to systems and methods for providing communications services wherein payment for the communication services is based on alternative payment schemes.

Conventional telecommunication services today typically employ a “pay-as-you-go” subscription scheme wherein subscribers enter into service contracts and agree to pay sums of money corresponding to the amount of service used. Customers using this service are periodically billed for their usage and remit payment in the form of money for the services rendered. This conventional “money-for-service” scheme has existed for centuries.

In media and broadcasting sectors, however, alternate forms of service compensation are commonly used. For example, network television and radio broadcasts rely on advertising to generate revenue that pays for the production and transmission of such programs. This relieves consumers of the burden of having to make monetary payments for such services, which are generally considered to be “free” by most consumers. The tradeoff of service for exposure to advertising has been widely accepted by consumers and is considered by many to be a desirable and often a preferable alternative to monetary payments.

However, in the telecommunications sector, no such alternative payment schemes currently exist for telecommunications services.

Accordingly, it would be desirable to provide systems and methods that provide alternative payment schemes for telecommunications services.

It would therefore be further desirable to provide systems and methods that allow consumers to receive telecommunications services in exchange for listening to or viewing certain content or advertising.

### SUMMARY OF THE INVENTION

It is therefore an object of the present invention to provide alternative payment schemes for telecommunications services.

It is therefore another object of the present invention to provide systems and methods that allow consumers to receive telecommunications services in exchange for listening to or viewing certain content or advertising.

These and other objects of the invention are provided in accordance with the principles of the present invention by providing systems and methods for an alternative payment scheme for telecommunications services.

The systems and methods according to preferred embodiments of the present invention may include a user communications device capable of playing an electronic content clip; a communications network for transferring electronic content to and from the user communications device; and an electronic content server that stores electronic content clips and provides electronic content clips to the user communications device such that an electronic content clip must be reviewed by a user prior to the user completing an electronic communication with the user communications device.

### BRIEF DESCRIPTION OF THE DRAWINGS

The above and other objects and advantages of the present invention will be apparent upon consideration of the following detailed description, taken in conjunction with the accompanying drawings in which:

FIG. 1 shows a generalized block diagram of a system constructed in accordance with the principles of preferred embodiments of the present invention for providing alternative payment schemes for telecommunications services.

FIG. 2 is a flow chart illustrating some of the steps involved in providing alternative payment schemes for telecommunications services.

### DETAILED DESCRIPTION OF THE INVENTION

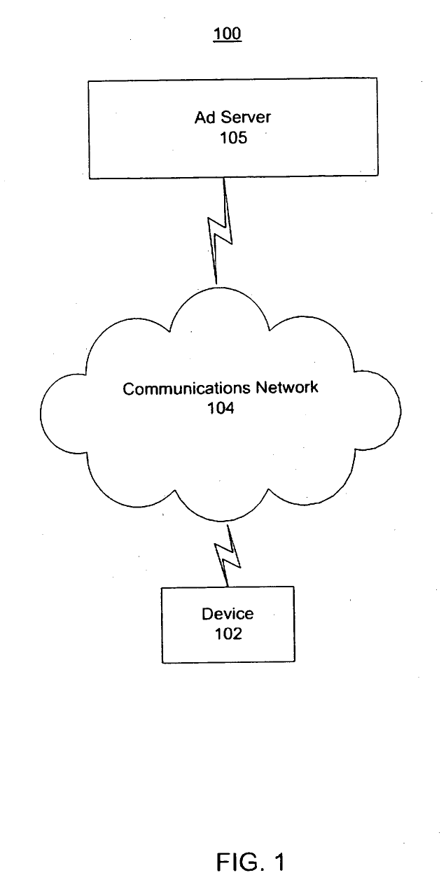

FIG. 1 shows a generalized diagram of a system 100 for providing telecommunications services to end user terminals in accordance with the principles of preferred embodiments of the present invention. System 100 may generally include user communications device 102, communications network 104, and advertising server 105.

Communications network 104 may be any known public or private telecommunications network such as a conventional hard-wired or wireless telephone communication system. Network 104 may also include portions of the Internet, a WAN (wide area network), a LAN (local area network), an intranet and/or any other network or portion of a network suitable for transmitting electronic data. Network 104 may communicate with device 102 and server 105 and may request, initiate, control, and monitor the transfer of data between server 105 and device 102.

Server 105 may be any suitable electronic device capable of storing, retrieving, and/or providing electronic content as needed to network 104 and device 102. For example, server 105 may be a computer, a server or any other suitable electronic content distribution point. In some embodiments, server 105 may monitor communications across network 104 in order to provide content to device 102 upon the occurrence of certain events (e.g., the placing of a telephone call by a user of device 102 (discussed in more detail below)).

User communications device 102 may be any portable handset or desktop system capable of receiving incoming communications, such as a wireless or cordless telephone, or a text messaging or email capable device. For example, communications device 102 may be a pager, a Blackberry™, a Treo™, or a personal computer that can receive incoming information from an external network such as the Internet. In some embodiments, device 102 may have at least minimal processing and storage capabilities in order to playback previously stored content such as audio and/or video content sent from server 105. Device 102 may also include certain software applications to facilitate playback of any content transmitted from server 105, whether previously stored or currently transmitted (not shown). Moreover, although only one server 105 and one device 102 are shown in FIG. 1, it will be understood that additional ones may be incorporated into system 100 if desired.

Generally speaking, the system of FIG. 1 may operate as follows. An end user (not shown) may be provided with communication device 102 (e.g., by a communications service provider) for the purpose of making and receiving electronic communications. It is assumed for the purpose of illustration that device 102 is a wireless telephone. The end user may agree in advance that in exchange for being able to make cost free or reduced cost telephone calls that he or she will listen to and/or view an advertisement(s) prior to making a call. On this basis, device 102 may be provided free of charge to the end user (or for a nominal fee) with a free or substantially free communications service included (in the case of a wireless telephone service).

In this embodiment, device 102 may be assigned certain electronic indicia identifying it as a “free phone” or “ad phone” such as a special telephone number, an electronic serial number (ESN), or any other suitable indicia. When the user places a call using device 102, the indicia may be received by network 104 and recognized by server 105, which may monitor communications across network 104 for such information. In other embodiments, however, portions of network 104 may monitor the communications and make content requests from server 105 using any suitable communication request mechanism (e.g., polling).

In the former case, when a user makes a telephone call, server 105 may recognize the transmitted indicia from the user's device 102 and may retrieve a particular piece of content, such as an advertisement, and transmit that content to device 102 across network 104 for review by the user. After the user reviews the transmitted content, the user's telephone call may be completed. In some embodiments, device 102 may send a confirmation signal back to network 104 or server 105 to confirm the user has successfully reviewed the transmitted content. In such embodiments, the user's call may not be completed until the confirmation signal is received.

In accordance with one aspect of the invention, server 105 may store various types of electronic content such as text, audio and/or image information including multimedia content and may include, for example, WAV, MP3, XVID, WMA files or any other suitable files that may be sent to device 102. In wireless embodiments, these files may be WAP compliant. In a preferred embodiment, the content may include short advertisement or promotional clips such as commercials or trailers. However, any suitable electronic content may be used if desired.

When a user initially receives device 102, he or she may be required to complete a survey or questionnaire supplying demographic, product preference, and/or other personal or professional information in order to activate the device for functional use. This may be accomplished using any input/output device present on device 102 such as a keyboard or touch screen. It should also be noted that such information may be input into a user account via any other suitable means such as a computer linked to the internet or voice communications with a customer service representative. The survey may need to be periodically updated in order to maintain free or substantially free telecommunications service. Thus, in some embodiments, device 102 may become inactive after a period time and the user may be required to complete an additional or different set of survey questions in order to maintain telecommunications service.

In some embodiments of the present invention, survey responses may be sent to server 105 using simple text messages or any other suitable communications means. For example, a text message may contain only a survey number that corresponds to a particular survey and the survey responses (without sending the actual survey itself). New or updated surveys may be periodically communicated to device 102 (e.g., while the user is listening to previously downloaded content).

The survey results may be collected and stored in server 105 and a user profile may be created based on the survey results. Server 105 may then associate a user's profile information with the electronic indicia of a particular device 102 and use such profile information to determine appropriate content to send to that particular device 102. In this way, server 105 may provide effective targeted advertising and/or other content to send to a particular user.

Moreover, server 105 may also create and maintain a database of content that is sent to a particular device 102. Server 105 may also monitor how often content is sent to a particular device 102. This database coupled with the monitoring capabilities may be employed in order to prevent the undesired repetition of content to a particular device 102 and also to ensure that the user is receiving a suitable variety of information. Server 105 may also monitor particular public numbers frequently called by a user (e.g., movie theaters, restaurants, etc.) in order to further target the content transmissions. In addition, survey results and/or user profiles stored on server 105 may be remotely accessed and downloaded for use in other marketing or profiling applications.

Once a user profile is created, server 105 may download appropriate content using one or more side channels, alternative frequencies, etc. while the user is reviewing previously stored content. This may reduce the transmission burden on portions of network 104, such as a cell tower or other transmission point.

In operation, a user of device 102 may receive calls from others who are using devices similar to device 102 or may receive calls from conventional subscription-based callers. In the case where the incoming call is from another device 102 or similar device (not shown), both the caller and the call recipient may be provided with a content clip from server 105 that must be reviewed before the call may proceed. In the case where the incoming call is from a subscription caller, it may not be permissible (or possible) to require the subscription caller to review content. In this case, only the call recipient may be required to view a content clip and then the call may be routed to device 102. However, if it is permissible to require a subscription caller to review content, server 105 may also provide the subscription caller with content to be reviewed before the call is allowed to proceed.

In some embodiments, call length may be limited by the amount of content reviewed. For example, a user of device 102 may place a call after reviewing the required content. If the length of that call exceeds a certain predefined or other time period (e.g., ten minutes), the user of device 102 may be required to review additional content in order for the call to continue. In this case, server 105 may temporarily suspend or place the ongoing call on hold while the user reviews the additional content. If the user declines to review the additional content, the call may be terminated. In some embodiments, where the user realizes in advance the call may exceed a certain time length, the user may choose to review a sufficient amount of content in advance so the longer call may proceed uninterrupted.

Another aspect of the invention involves the shape of device 102. To further the advertising goals of the present invention, device 102 may be constructed in the shape of a particular product, such as a soda can or other type of good so that the general public is exposed to the product brand or label while the user is communicating with device 102.

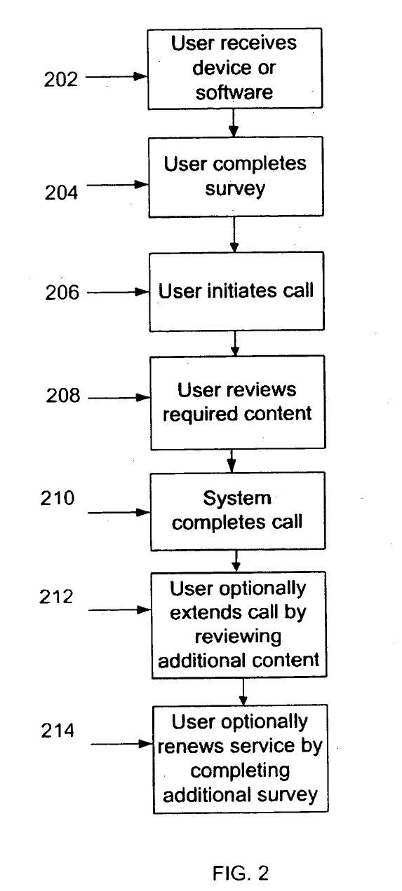

Some of the steps involved in providing alternative payment schemes for telecommunications services in accordance with the present invention are illustrated in flow chart 200 shown in FIG. 2. As shown, at step 202, a user may consult a customer service representative or visit a website and agree to the terms of the service and receive device 102 (or the software to run the service on an existing device). Next, at step 204, the user may initialize device 102 by completing an initial demographics or other suitable survey. This information may then be sent to server 105 which may compile the response to create a user profile. The user profile may be associated with unique indicia of device 102 so that server 105 may recognize the particular device 102 and use such indicia to index a database of stored profiles.

At step 206, the user may initiate a call or other electronic communication with device 102. The call may be routed via network 104, which may be monitored by server 105. At step 208, server 105 may recognize a particular device 102 and may interrupt or suspend the call and provide content for the user to review. In some embodiments, server 105 may merely prompt device 102 to play previously stored content and download additional new content to device 102 for future use as the user reviews the stored content.

Next, at step 210, the call is completed and the user may communicate with the call recipient for a predetermined period. If the call exceeds the predetermined period, server 105 may interrupt the call and provide the user with the option of continuing the call by reviewing additional content (step 212). If the user declines, the call may be terminated. If the user accepts, the current call may be placed on hold or suspended while the user reviews the new content. Afterwards, the call may be reinstated. The user may then complete the call and continue operating in this fashion for a certain period of time after which service may again be suspended. At this point (step 214), the user may be prompted to complete an additional survey or provide additional information to renew the service.

Thus, systems and methods for providing alternative payment schemes for telecommunications services are provided. It will be understood that the foregoing is only illustrative of the principles of the invention and that various modifications may be made by those skilled in the art without departing from the scope and spirit of the invention. Accordingly, such embodiments will be recognized as within the scope of the present invention.

Persons skilled in the art will appreciate that the present invention can be practiced by other than the described embodiments, which are presented for purposes of illustration rather than of limitation and that the present invention is limited only by the claims that follow.

What is claimed is:

1. A system for providing an alternative payment scheme for telecommunications services comprising:
a user communications device capable of playing an electronic content clip;
a communications network for transferring electronic content to the user communications device; and
an electronic content server that stores electronic content clips and provides electronic content clips to the user communications device such that an electronic content clip must be reviewed by a user prior to the user completing an electronic communication with the user communications device.

2. The system of claim 1, wherein the content server stores user profiles.

3. The system of claim 2, wherein the user profiles are at least partially based upon information provided by the user in response to a survey.

4. The system of claim 2, wherein the user profiles are at least partially based upon information obtained my monitoring telephone numbers dialed by the user.

5. The system of claim 2, wherein the user profiles are at least partially based upon information obtained by monitoring Internet websites visited by the user using the user communications device.

6. The system of claim 2, wherein the information contained within the user profile is used as at least a partial basis for providing targeted advertising to the user.

7. The system of claim 2, wherein a particular
user profile is correlated with a particular user communications device using device indicia.

8. The system of claim 7, wherein device indicia includes an electronic serial number.

9. The method of claim 7, wherein device indicia includes a telephone number.

10. The system of claim 1, wherein the electronic communication terminates after a predefined period of time.

11. The system of claim 10, wherein the user optionally reviews additional electronic content clips to extend the electronic communication.

12. A method for providing an alternative payment scheme for telecommunications services comprising:
providing one or more surveys to a user;
creating a user profile based upon the information obtained from the surveys;
selecting an electronic content clips based upon information obtained from the user surveys;
transferring the selected electronic content clip from an electronic content server to a user communications device capable of playing the electronic content clip via a communications network;
requiring the user to review the electronic content clip prior to the user being allowed to complete an electronic communication; and
completing the electronic communication after the user has reviewed the electronic content clip.

13. The method of claim 12, wherein a completed electronic communication terminates after a predefined period of time.

14. The method of claim 13, wherein the predetermined time period is based upon the number of electronic content clips viewed by the user.

15. The method of claim 14, further comprising:
optionally reviewing one or more additional electronic content clips to extend the electronic communication.

16. The method of claim 12, further comprising storing the user profile on the electronic content server.

17. The method of claim 12, further comprising:
correlating a particular user profile with a particular user communications device using device indicia.

18. The method of claim 17, wherein device indicia includes an electronic serial number.

19. The method of claim 17, wherein device indicia includes a telephone number.

20. A system for providing an alternative payment scheme for telecommunications services comprising:
means for providing one or more surveys to a user;
means for creating a user profile based upon the information obtained from the survey;
means for selecting electronic content clips based upon information obtained from the survey;
means for transferring the selected electronic content clips from an electronic content server to a user communications device capable of playing the electronic content clips; and
means for completing an electronic communication after the user has reviewed at least one electronic content clip.

21. The system of claim 20, further comprising:
means for correlating a particular user profile with a particular user communications device.

22. The system of claim 20, wherein the means for completing the user's electronic communication terminates after a predefined period of time.
